(19) United States
(12) Patent Application Publication
(10) Pub. No.: US 2024/0420076 A1
(43) Pub. Date: Dec. 19, 2024

(54) DELIVERY ASSISTANCE DEVICE

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/740,517

(22) Filed: Jun. 12, 2024

(30) Foreign Application Priority Data
Jun. 16, 2023 (JP) 2023-099306

(51) Int. Cl. G06Q 10/0835

(52) U.S. Cl. CPC G06Q 10/08355

(57) ABSTRACT

A delivery assistance device includes controller that creates a parcel delivery route of a delivery vehicle loaded with multiple parcels. The controller obtains position information of the multiple parcels in the delivery vehicle. The controller creates the delivery route based on the position information of the multiple parcels such that a parcel at a position where the parcel is easily unloaded from the delivery vehicle can be delivered to a delivery destination earlier than a parcel at a position where the parcel is not easily unloaded from the delivery vehicle.

### CROSS-REFERENCE TO RELATED APPLICATIONS

This application is based upon and claims the benefit of priority from prior Japanese Patent Application No. 2023-099306, filed on Jun. 16, 2023, the entire contents of which are incorporated herein by reference.

### BACKGROUND

### 1. Field

The present disclosure relates to a delivery assistance device that assists delivery of parcels by a delivery vehicle.

### 2. Description of Related Art

Japanese Laid-Open Patent Publication No. 2022-76394 discloses a delivery assistance device that sets a delivery route of a delivery vehicle based on recipient information of a parcel to be delivered.

When the delivery vehicle arrives at a delivery destination, a delivery person unloads the parcel from the delivery vehicle. In order to efficiently perform unloading, it is necessary to load parcels on the delivery vehicle in consideration of a delivery order determined by a delivery route. In a case in which multiple parcels are loaded on a delivery vehicle such that unloading at delivery destinations can be efficiently performed, a worker who is aware of the delivery route needs to load the parcels. In other words, a worker who is not aware of the delivery route cannot load parcels onto the delivery vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a delivery assistance device includes a controller that includes processing circuitry configured to create a parcel delivery route of a delivery vehicle loaded with multiple parcels. The processing circuitry is configured to obtain position information of the multiple parcels in the delivery vehicle. The processing circuitry is also configured to create the delivery route based on the position information of the multiple parcels such that a parcel at a position where the parcel is easily unloaded from the delivery vehicle can be delivered to a delivery destination earlier than a parcel at a position where the parcel is not easily unloaded from the delivery vehicle.

Other features and aspects will be apparent from the following detailed description, the drawings, and the claims.

### BRIEF DESCRIPTION OF THE DRAWINGS

FIG. 1 is a configuration diagram illustrating a delivery assistance device, an information obtaining device, a delivery vehicle, and an information terminal according to a first embodiment.

FIG. 2 is a perspective view schematically showing a state in which multiple parcels are loaded on the delivery vehicle shown in FIG. 1.

FIG. 3 is a sequence diagram illustrating a flow of processes for creating a parcel delivery route in the delivery assistance device according to the first embodiment.

FIG. 4 is a sequence diagram illustrating a flow of processes for creating a parcel delivery route in the delivery assistance device according to a second embodiment.

FIG. 5 is a schematic diagram illustrating an example of a delivery route with the highest delivery efficiency of parcels.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

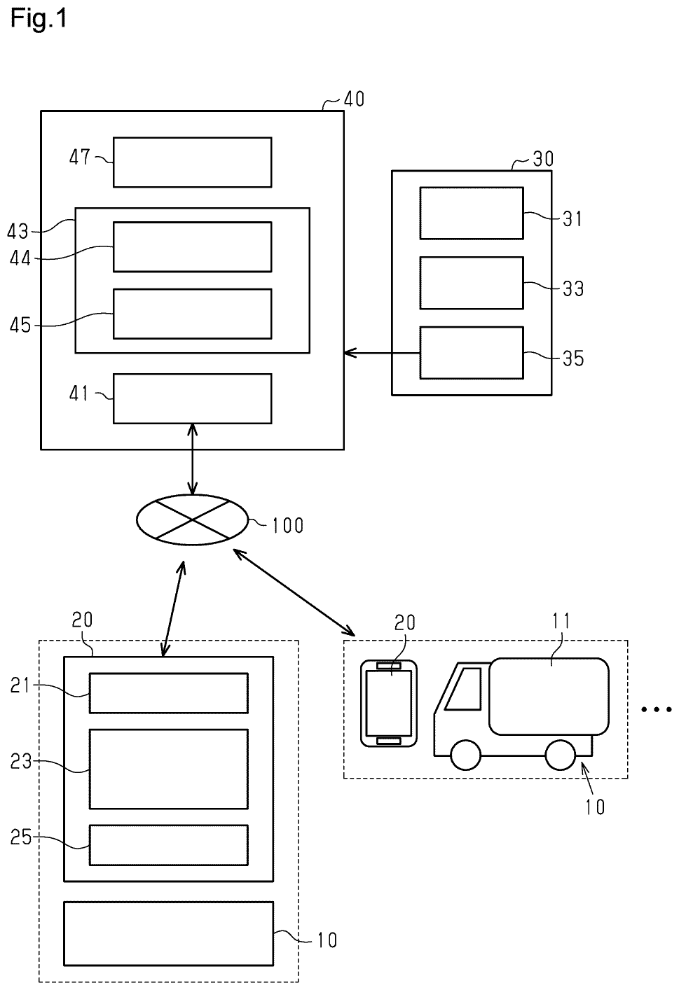

Hereinafter, a first embodiment of a delivery assistance device will be described with reference to FIGS. 1 to 3.

FIG. 1 illustrates a delivery assistance device 40, an information obtaining device 30, multiple delivery vehicles 10, and multiple information terminals 20.

### Delivery Vehicle and Information Terminal

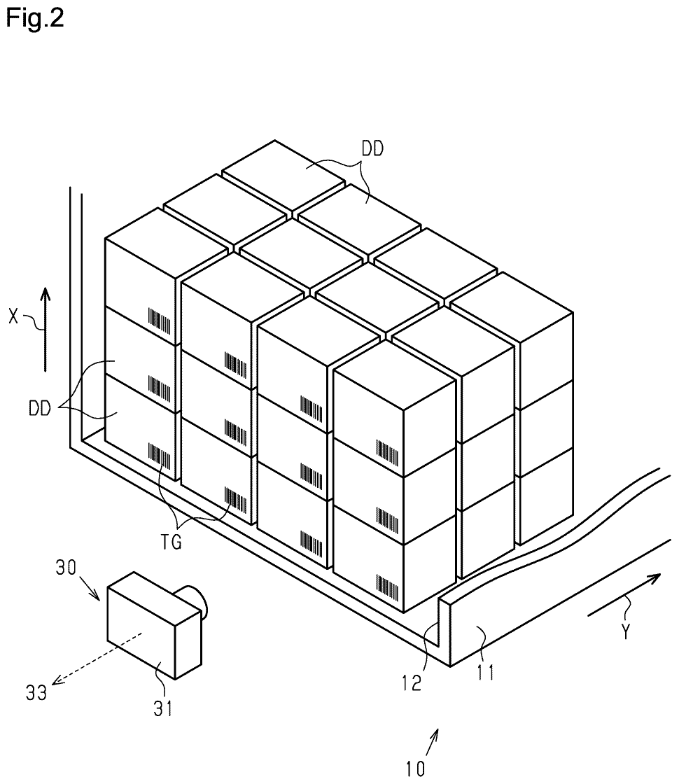

The delivery vehicle 10 is a vehicle managed by the delivery assistance device 40. The delivery vehicle 10 includes a cargo bed 11. As shown in FIG. 2, multiple parcels DD can be loaded on the cargo bed 11.

As shown in FIG. 1, the information terminal 20 is a communication device owned by a delivery person riding on the delivery vehicle 10. The information terminal 20 is configured to communicate with the delivery assistance device 40 via the communication network 100. Examples of the information terminal 20 include a smartphone and a tablet terminal.

For example, the information terminal 20 includes a communication device 21, a user interface 23, and processing circuitry 25. The communication device 21 outputs information received from the delivery assistance device 40 via the communication network 100 to the processing circuitry 25. The communication device 21 transmits information output from the processing circuitry 25 to the delivery assistance device 40 via the communication network 100.

The user interface 23 includes a display screen and an operation unit. An example of the processing circuitry 25 is an electronic controller. When the operation unit is operated by the delivery person, the processing circuitry 25 executes processing corresponding to the operation. When the communication device 21 receives information from the delivery assistance device 40 via the communication network 100, the processing circuitry 25 causes the information received by the communication device 21 to be displayed on the display screen of the user interface 23.

### Information Obtaining Device

As illustrated in FIGS. 1 and 2, the information obtaining device 30 includes an imaging device 31 such as a camera, processing circuitry 33, and a communication device 35. The processing circuitry 33 analyzes image data which is data of an image captured by the imaging device 31. The communication device 35 transmits information on the analysis result of the processing circuitry 33 to the delivery assistance device 40.

An example of the analysis processing of the image data will be described with reference to FIG. 2. FIG. 2 shows a state in which a large number of parcels DD are loaded on the cargo bed 11 of the delivery vehicle 10. A tag TG is attached to each of the multiple parcels DD. Identification information for identifying the parcel DD is registered in the tag TG. An example of the tag TG is the radio frequency identification (RFID).

The imaging device 31 images a state in which the worker loads the parcel DD on the cargo bed 11 of the delivery vehicle 10. At this time, the worker loads the parcel DD into the delivery vehicle 10 so that the tag TG attached to the parcel DD can be imaged by the imaging device 31.

The imaging device 31 images the inside of the cargo bed 11 on which the cargo DD is loaded. Then, the imaging device 31 generates image data which is data of an image from which the position of the parcel DD in the cargo bed 11 can be recognized. The imaging device 31 outputs the generated image data to the processing circuitry 33. For example, the imaging device 31 generates image data by imaging the inside of the cargo bed 11 every time the cargo DD is loaded on the cargo bed 11. Each time the imaging device 31 generates image data, the imaging device 31 outputs the image data to the processing circuitry 33.

When the imaging data is input from the imaging device 31, the processing circuitry 33 of the information obtaining device 30 analyzes the image indicated by the imaging data. Specifically, the processing circuitry 33 obtains position information which is information on the position of the parcel DD in the delivery vehicle 10. For example, the processing circuitry 33 obtains, as the position information, height position information which is information regarding the position of the parcel DD in the height direction X and depth position information which is information regarding the position of the parcel DD in the depth direction Y. The height direction X is a vehicle upward direction of the delivery vehicle 10. For example, when multiple parcels DD are stacked, it can be said that the height direction X is the stacking direction of the parcels DD. The depth direction Y is a direction away from the carry-in port 12 provided in the rear portion of the delivery vehicle 10. That is, the depth direction Y is the front of the vehicle. The carry-in port 12 is an opening through which the cargo DD is carried in and out of the cargo bed 11.

Further, the processing circuitry 33 reads the tag TG of the parcel DD shown in the image represented by the imaging data. Then, the processing circuitry 33 outputs the tag TG read from the image to the delivery assistance device 40 together with the position information of each parcel DD.

### Delivery Assistance Device

A configuration of the delivery assistance device 40 will be described with reference to FIG. 1.

The delivery assistance device 40 includes a communication device 41, a controller 43, and a database 47.

The communication device 41 is an interface of the delivery assistance device 40 for transmitting and receiving information between the delivery assistance device 40 and an external communication device via the communication network 100. For example, the communication device 41 outputs information received via the communication network 100 to the controller 43. Further, for example, the communication device 41 transmits information output by the controller 43 to the information terminal 20 via the communication network 100.

An example of the controller 43 is an electronic controller. In this case, the controller 43 includes a CPU 44 and a memory 45. The memory 45 stores a control program executed by the CPU 44. When the CPU 44 executes the control program, the controller 43 executes a series of processes for creating a delivery route of the parcel DD of the delivery vehicle 10.

Information necessary for the controller 43 to create a delivery route is registered in the database 47. For example, information on delivery destinations of multiple parcels DD is registered in the database 47. The information on the delivery destination includes an address of the delivery destination.

Flow of Processes when Creating Delivery Route

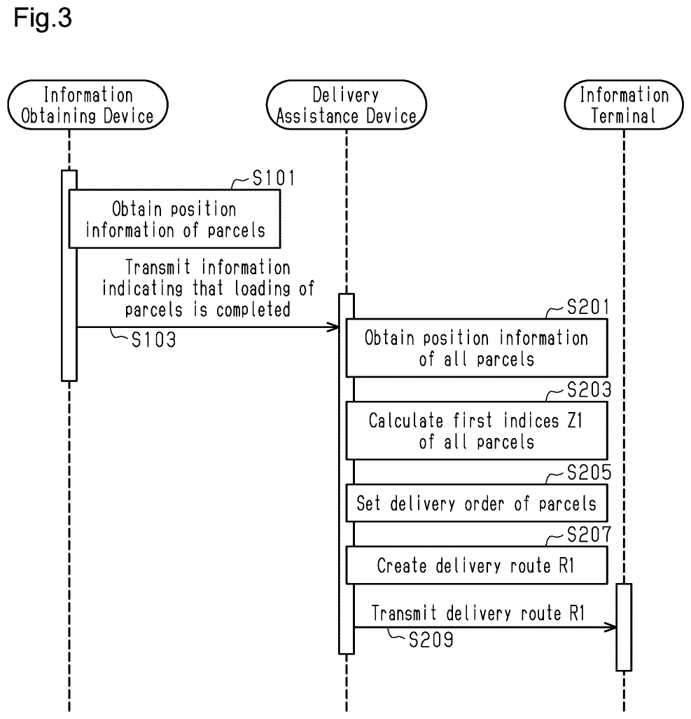

An example of a flow of processing when the first delivery route RT1 which is the delivery route of the parcel DD is created will be described with reference to FIG. 3.

The worker starts loading the delivery vehicle 10 with the parcel DD. Then, the processing circuitry 33 of the information obtaining device 30 executes the process of step S101. In step S101, the processing circuitry 33 obtains the position information of the parcel DD in the delivery vehicle 10 based on the image captured by the imaging device 31. The processing circuitry 33 executes the process of step S101 until loading of the parcel DD onto the delivery vehicle 10 is completed. When the loading of the parcel DD is completed, the processing circuitry 33 can obtain the position information of all the parcels DD in the cargo bed 11. Therefore, the information obtaining device 30 executes the process of step S103. In step S103, the communication device 35 of the information obtaining device 30 transmits information indicating that loading of the parcel DD onto the delivery vehicle 10 has been completed to the delivery assistance device 40. At this time, the communication device 35 also transmits the position information of the multiple parcels DD to the delivery assistance device 40.

When the communication device 41 of the delivery assistance device 40 receives the completion of the loading of the parcel DD onto the delivery vehicle 10 from the information obtaining device 30, the delivery assistance device 40 executes the process of step S201.

In step S201, the controller 43 of the delivery assistance device 40 obtains the position information of all the parcels DD loaded in the delivery vehicle 10. In the next step S203, the controller 43 calculates the first indices Z1 of all the parcels DD loaded on the delivery vehicle 10 based on the position information of the multiple parcels DD. The first index Z1 is an index indicating easiness of unloading from the delivery vehicle 10. For example, the value indicated by the first index Z1 of the parcel DD placed at a position where it is easy to unload the parcel DD from the delivery vehicle 10 is smaller than the value indicated by the first index Z1 of the parcel DD placed at a position where it is difficult to unload the parcel DD from the delivery vehicle 10.

Here, the parcel DD located at a high position in the height direction X is more easily unloaded than the parcel DD located at a low position in the height direction X. That is, in a situation where multiple parcels DD are stacked, when a parcel DD located at a low position in the height direction X is unloaded, it is necessary to move another parcel DD placed on the parcel DD. Therefore, the value indicated by the first index Z1 of the parcel DD located at a low position in the height direction X is relatively large.

In addition, the parcel DD located on the near side in the depth direction Y is more easily unloaded than the parcel DD located on the far side in the depth direction Y. That is, when unloading the parcel DD located on the far side, it is necessary to move another parcel DD located on the near side of the parcel DD. Therefore, the value indicated by the first index Z1 of the parcel DD positioned on the far side in the depth direction Y is relatively large.

When the controller 43 completes the calculation of the first index Z1 in this way, the controller 43 shifts the processing to step S205. In step S205, the controller 43 sets the delivery order of the multiple parcels DD based on the first indices Z1 of the multiple parcels DD calculated in step S203. For example, the controller 43 sets the delivery order of the multiple parcels DD such that a parcel DD having a small value indicated by the first index Z1 can be delivered to a delivery destination before a parcel DD having a large value indicated by the first index Z1. Then, in step S207, the controller 43 creates a delivery route capable of delivering the parcel DD in the delivery order set in step S205 as the first delivery route RT1. That is, the controller 43 creates the first delivery route RT1 such that the parcel DD at a position at which the parcel DD is easily unloaded from the delivery vehicle 10 can be delivered to the delivery destination earlier than the parcel DD at a position at which the parcel DD is not easily unloaded from the delivery vehicle 10 based on the position information of the multiple parcels DD.

In the next step S209, the communication device 41 of the delivery assistance device 40 transmits the information on the first delivery route RT1 created by the controller 43 to the information terminals 20 of the delivery persons riding on the delivery vehicle 10.

Thereafter, the delivery vehicle 10 delivers the parcel DD according to the first delivery route RT1.

### Operation and Advantages of Present Embodiment

(1-1) When the parcels DD are loaded into the delivery vehicle 10, the controller 43 of the delivery assistance device 40 obtains the position information of the parcels DD in the delivery vehicle 10. The controller 43 creates the first delivery route RT1 based on the position information of the multiple parcels DD. The first delivery route RT1 is a delivery route for delivering a parcel DD placed at a position where the parcel DD can be easily unloaded from the delivery vehicle 10 to the delivery destination earlier than a parcel DD placed at a position where the parcel DD cannot be easily unloaded from the delivery vehicle 10.

Since the delivery route is created based on the position information of the parcels DD in the delivery vehicle 10 as described above, the worker who loads the parcels DD into the delivery vehicle 10 does not need to be aware of the delivery route. Therefore, with the delivery assistance device 40, even a worker who is not aware of the delivery route can load the parcels DD on the delivery vehicle 10.

(1-2) The delivery vehicle 10 delivers the parcels DD according to the first delivery route RT1. For example, when the delivery vehicle 10 arrives at a first delivery destination, the delivery person unloads the parcel DD addressed to the first delivery destination from the delivery vehicle 10. At this time, the parcel DD addressed to the first delivery destination is arranged at a position where the parcel DD can be easily unloaded on the cargo bed 11. Therefore, when the delivery person unloads the parcel DD at the delivery destination, the delivery assistance device 40 prevents the time required to unload parcel DD from being extended.

### Second Embodiment

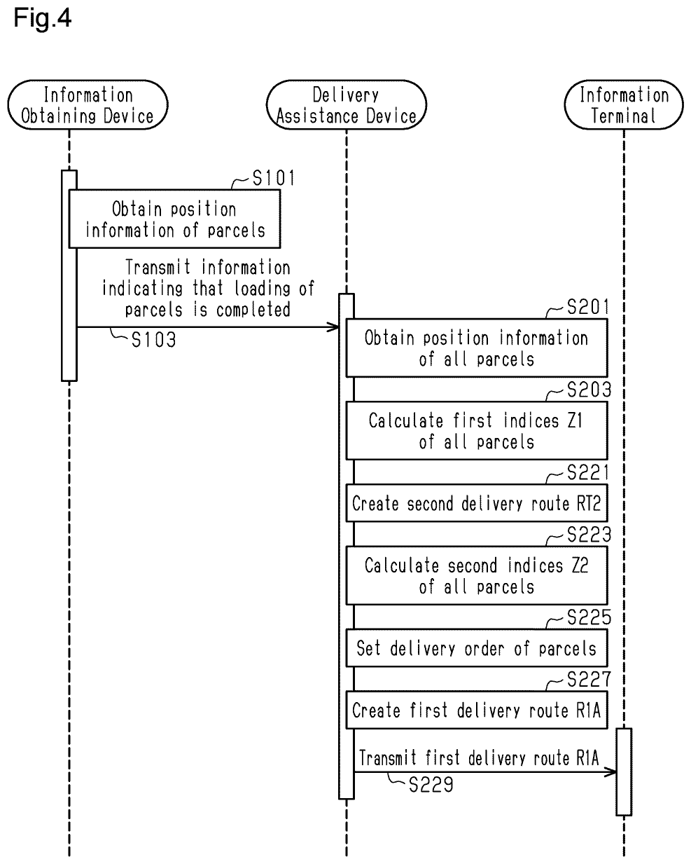

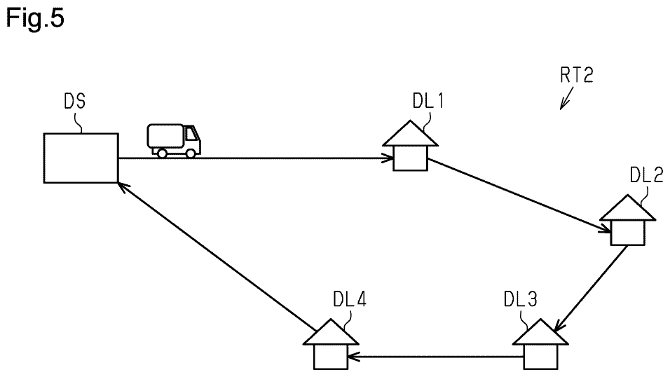

A second embodiment of the delivery assistance device will be described with reference to FIGS. 4 and 5. In the second embodiment, a method of determining the first delivery route is different from that of the first embodiment. In the following description, portions different from those of the first embodiment will be mainly described, and the same members and configurations as those of the first embodiment will be denoted by the same reference numerals, and redundant description thereof will be omitted.

An example of a flow of processing when the first delivery route RT1A is created in the present embodiment will be described with reference to FIGS. 4 and 5.

The worker starts loading the delivery vehicle 10 with the parcel DD. Then, the processing circuitry 33 of the information obtaining device 30 executes the process of step S101. In step S101, the processing circuitry 33 obtains the position information of the parcel DD in the delivery vehicle 10 based on the image captured by the imaging device 31. The processing circuitry 33 executes the process of step S101 until loading of the parcel DD onto the delivery vehicle 10 is completed. In the next step S103, the communication device 35 of the information obtaining device 30 transmits information indicating that loading of the parcel DD onto the delivery vehicle 10 has been completed to the delivery assistance device 40. At this time, the communication device 35 also transmits the position information of the multiple parcels DD to the delivery assistance device 40.

When the communication device 41 of the delivery assistance device 40 receives the completion of the loading of the parcel DD onto the delivery vehicle 10 from the information obtaining device 30, the delivery assistance device 40 executes the process of step S201.

In step S201, the controller 43 of the delivery assistance device 40 obtains the position information of all the parcels DD loaded in the delivery vehicle 10. In the next step S203, the controller 43 calculates the first indices Z1 of all the parcels DD loaded on the delivery vehicle 10 based on the position information of the multiple parcels DD.

In the subsequent step S221, the controller 43 creates a second delivery route RT2. FIG. 5 shows an example of the second delivery route RT2. As shown in FIG. 5, the second delivery route RT2 is a delivery route along which the delivery vehicle 10 departs from the delivery center DS, travels around multiple delivery destinations DL1, DL2, DL3, and DL4 in order, and then returns to the delivery center DS. Specifically, the second delivery route RT2 is the most efficient delivery route for the parcel DD. An example of the second delivery route RT2 is a delivery route that can minimize the mileage of the delivery vehicle 10. The controller 43 can create the second delivery route RT2 based on the position information of the delivery destinations of the multiple parcels DD.

Returning to FIG. 4, after creating the second delivery route RT2, the controller 43 shifts the processing to step S223. In step S223, the controller 43 calculates the second indices Z2 of all the parcels DD loaded in the delivery vehicle 10 based on the second delivery route RT2. The second index Z2 is an index indicating the order in which the parcel DD is unloaded from the delivery vehicle 10 when it is assumed that the parcel DD is delivered by the delivery vehicle 10 according to the second delivery route RT2. The value indicated by the second index Z2 of the parcel DD to be unloaded earlier is smaller than the value indicated by the second index Z2 of the parcel DD to be unloaded later.

In step S225, the controller 43 sets the delivery order of the multiple parcels DD based on the first indices Z1 of the multiple parcels DD calculated in step S203 and the second indices Z2 of the multiple parcels DD calculated in step S223. For example, the controller 43 sets the delivery order of the multiple parcels DD such that the parcel DD having a small sum of the value indicated by the first index Z1 and the value indicated by the second index Z2 can be delivered earlier than the parcel DD having a large sum of the value indicated by the first index Z1 and the value indicated by the second index Z2. Then, in step S227, the controller 43 creates a delivery route capable of delivering the parcel DD in the delivery order set in step S225 as the first delivery route RT1A.

In the next step S229, the communication device 41 of the delivery assistance device 40 transmits the information on the first delivery route RT1A created by the controller 43 to the information terminals 20 of the delivery persons riding on the delivery vehicle 10.

Thereafter, the delivery vehicle 10 delivers the parcel DD according to the first delivery route RT1A.

### Operation and Advantages of Present Embodiment

The delivery assistance device 40 of the present embodiment can obtain the following effects in addition to the effect (1-1) of the first embodiment.

(2-1) The controller 43 of the delivery assistance device 40 creates the first delivery route RT1A in consideration of both easiness of unloading from the delivery vehicle 10 and delivery efficacy. Consequently, the delivery assistance device 40 prevents the time required to unload from delivery vehicle 10 at the delivery destinations from being extended, while limiting reduction in the delivery efficiency by delivery vehicle 10.

### Modifications

The above-described embodiments may be modified as follows. The above-described embodiments and the following modifications can be combined as long as the combined modifications remain technically consistent with each other.

In the second embodiment, the controller 43 may create the first delivery route RT1A based on the product of the value indicated by the first index Z1 and the value indicated by the second index Z2. Even in this case, it can be said that the first delivery route RT1A is a delivery route created based on the first index Z1 and the second index Z2.

The controller 43 is not limited to a device that includes a CPU and a ROM and executes software processing. That is, the controller 43 may be modified if it has any one of the following configurations (a), (b), and (c).

(a) The controller 43 includes one or more processors that execute various processes according to computer programs. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The controller 43 includes one or more dedicated hardware circuits that execute various processes. The dedicated hardware circuits include, for example, an application specific integrated circuit (ASIC) and a field programmable gate array (FPGA).

(c) The controller 43 includes a processor that executes part of various processes according to programs and a dedicated hardware circuit that executes the remaining processes. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A delivery assistance device, comprising a controller that includes processing circuitry configured to create a parcel delivery route of a delivery vehicle loaded with multiple parcels, wherein the processing circuitry is configured to
obtain position information of the multiple parcels in the delivery vehicle; and
create the delivery route based on the position information of the multiple parcels such that a parcel at a position where the parcel is easily unloaded from the delivery vehicle can be delivered to a delivery destination earlier than a parcel at a position where the parcel is not easily unloaded from the delivery vehicle.

2. The delivery assistance device according to claim 1, wherein the processing circuitry is configured to obtain, as the position information of the parcels, information of positions of the parcels in a height direction in the delivery vehicle, and information of positions of the parcels in a depth direction in the delivery vehicle.

3. The delivery assistance device according to claim 1, wherein
the delivery route is defined as a first delivery route, and
the processing circuitry is configured to
calculate a first index that is an index indicating easiness of unloading of the parcel from the delivery vehicle, for each of the parcels based on the position information of the multiple parcels,
create a second delivery route that is a delivery route having a highest delivery efficiency of the parcels based on the position information of the delivery destinations of the multiple parcels;
calculate a second index for each parcel, the second index indicating an order in which the parcels are unloaded from the delivery vehicle when it is assumed that the parcels are delivered by the delivery vehicle along the second delivery route; and
when creating the first delivery route, create the first delivery route based on the first index and the second index.

4. The delivery assistance device according to claim 3, wherein the processing circuitry is configured to, when creating the first delivery route based on the first index and the second index, create the first delivery route such that a parcel for which a sum of the value indicated by the first index and the value indicated by the second index is smaller can be delivered to the delivery destination before a parcel for which a sum of the value indicated by the first index and the value indicated by the second index is larger.
